(19) United States
(12) Patent Application Publication
(10) Pub. No.: US 2015/0235072 A1
(43) Pub. Date: Aug. 20, 2015

(54) HYPERSPECTRAL IMAGE PROCESSING

(71) Applicant: BAE SYSTEMS PLC, London (GB)

(72) Inventors: Ainsley Killey, Bristol (GB); Gary John Bishop, Bristol (GB)

(73) Assignee: BAE SYSTEMS plc, London (GB)

(21) Appl. No.: 14/433,474

(22) PCT Filed: Oct. 2, 2013
(86) PCT No.: PCT/GB2013/052561

§ 371 Date: Apr. 3, 2015

(30) Foreign Application Priority Data
Oct. 5, 2012 (GB) 1217862.0

(51) Int. Cl. G06K 9/00

(52) U.S. Cl. CPC G06K 9/0063; G06K 2009/00644

(57) ABSTRACT

A system and method for hyperspectral image processing receives (202) partial hyperspectral image data representing a portion of a complete hyperspectral image. The method computes (204) estimated mean and covariance values for the partial hyperspectral image data, and executes (206) a hyperspectral image processing algorithm using the estimated mean and covariance values as estimates of global mean and covariance values for the complete hyperspectral image.

The present invention relates to hyperspectral image processing.

Most known hyperspectral imaging sensors only register one thin line of an image at a time. The image is built up by scanning the sensor across the scene, e.g. using a motorised stage or using the motion of an aircraft to scan across the landscape (push broom scanning). Existing hyperspectral detection systems only begin processing once the entire image has been captured, which can take several hours in the case of a sensor on an aircraft or the like. This greatly increases the time from important data being first captured to it being processed and interpreted.

This known method of processing also requires the whole image to be stored before any processing can occur. The high data rates associated with hyperspectral imagery (from 10's to 100's of MB/s) demand high storage capacity and throughput rates; meeting these requirements will inevitably lead to increased system cost.

The present invention is intended to address at least some of the problems discussed above. The invention provides a new method for processing hyperspectral data. Known hyperspectral detection algorithms rely on knowing the statistical properties of a scene. Whereas known image processing method/systems use the entire image to calculate the statistical properties exactly, the invention exploits the fact that a sample of this data can be used to produce an estimate. This allows the invention to run detection algorithms with only partial knowledge of the whole scene. As each line of hyperspectral data is received it can be used to improve the estimation of the statistical properties of the scene. This estimate can then be used with the detection algorithm to process that line. By processing the data as it is received, the invention can eliminate the need to store the entire image for later review and can allow the detection results to be processed immediately with only a small trade off in accuracy.

According to a first aspect of the present invention there is provided a method of hyperspectral image processing, the method including or comprising:

receiving partial hyperspectral image data representing a portion of a complete hyperspectral image;

computing estimated mean and covariance values for the partial hyperspectral image data, and

executing a hyperspectral image processing algorithm using the estimated mean and covariance values as estimates of global mean and covariance values for the complete hyperspectral image.

The method may further include:

receiving further partial hyperspectral image data representing a further portion of the complete hyperspectral image;

computing new estimated mean and covariance values as an average between the mean and covariance of the further partial hyperspectral image data and previously computed said estimated mean and covariance values, and

executing the hyperspectral image processing algorithm using the new estimated mean and covariance values as estimates of the global mean and covariance values for the complete hyperspectral image.

The partial hyperspectral image data may comprise a line of the complete hyperspectral image, which may be generated by a hyperspectral scanning process.

The partial hyperspectral image data may be received directly from a device, such as a camera, that generates the hyperspectral image data. Alternatively, the partial hyperspectral data may be received from a data store containing the complete hyperspectral image.

The hyperspectral image processing algorithm may comprise a target detection algorithm or an anomaly detection algorithm.

The method may further include transferring data relating to the hyperspectral image and/or data relating to a result of the hyperspectral image processing algorithm to a remote device. In some embodiments, the transferred data may comprise a portion of the hyperspectral image. In some embodiments, the transferred data may comprise a direct or indirect request for further hyperspectral image data.

Embodiments may only store the estimated mean and covariance values for further processing and not the hyperspectral image data.

According to another aspect of the present invention there is provided hyperspectral image processing apparatus including or comprising:

a device configured to receive partial hyperspectral image data representing a portion of a complete hyperspectral image;

a device configured to compute estimated mean and covariance values for the partial hyperspectral image data, and

a device configured to execute a hyperspectral image processing algorithm using the estimated mean and covariance values as estimates of global mean and covariance values for the complete hyperspectral image.

According to other aspects of the present invention there are provided computer program elements comprising: computer code means to make the computer execute methods substantially as described herein. The element may comprise a computer program product.

According to other aspects of the present invention there is provided apparatus including a processor configured to execute methods substantially as described herein.

According to further aspects of the present invention there are provided target and/or anomaly detection methods substantially as described herein.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

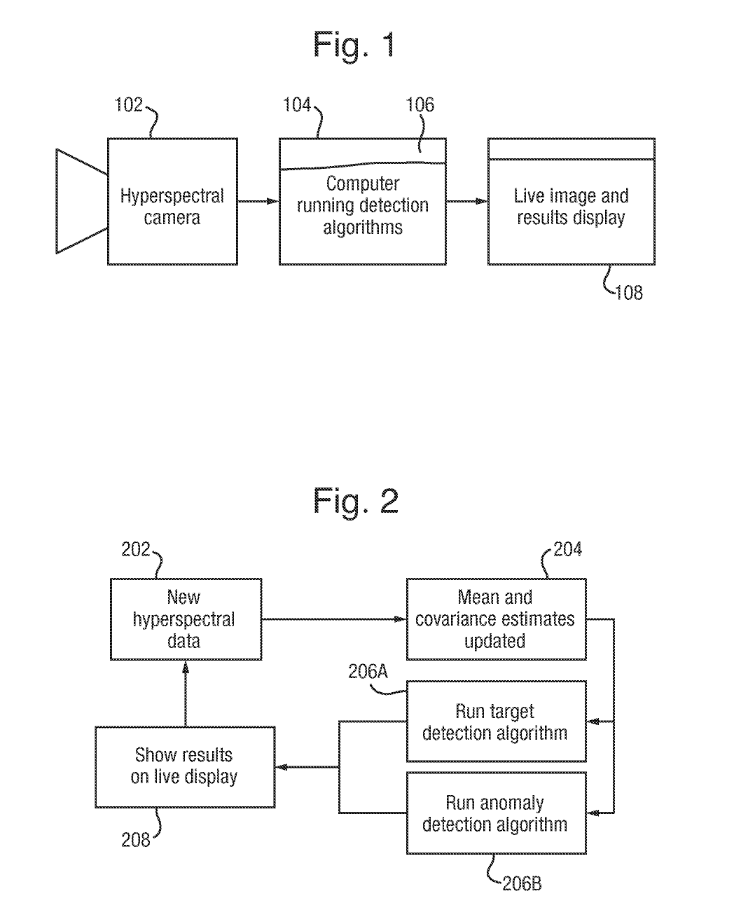

FIG. 1 is a block diagram of an example hyperspectral image processing system, and

FIG. 2 is a flowchart showing example steps that can be performed by the system.

FIG. 1 shows a hyperspectral camera 102, which can be any suitable known camera, such as a Specim AISA Eagle. In some cases the camera is fixed to a motorised stage to allow it to be directed under remote control, but in other cases the camera may be attached to a vehicle.

The camera 102 is in communication with a computing device 104 that is configured to receive hyperspectral image data from the camera and process it using an application 106. The computing device can be any suitable computing device having a processor and memory (e.g. a laptop or desktop personal computer) and can communicate with other devices, such as the camera, using any suitable wired or wireless communications link, e.g. WiFi™, USB Link, etc.

The computer 104 is also connected to, or includes, a display 108, such as an LCD monitor or any other suitable device, which can be used to display representations of the image data and/or other information relating to the results of the data processing. Although the components are shown as separate blocks in the Figure, and can be located remotely of each other (e.g. the camera 102 may be located on a street, the computing device within a control centre and the display in a monitoring station) it will be understood that in some embodiments, all or some of them could be integrated in a single device, e.g. a portable camera with an on board processing and/or display.

FIG. 2 illustrates schematically an example of main steps performed by the application 106 executing on the computing device 104. The skilled person will appreciate that these steps are exemplary only and that in alternative embodiments, some of them may be omitted and/or re-ordered. Further, the method can be implemented using any suitable programming language and data structures.

At step 202 data representing a portion of a complete hyperspectral image is received by the computing device 104. It will be understood that the data can be in any format, such as “Band Square (bsq)”, “Band Interleaved by Line (bil)” and “Band Interleaved by Pixel (bip)”, and in some cases data conversion, de-compression and/or decryption processes may be performed by the application 106. In some embodiments, the partial hyperspectral image data represents one line of a complete image that is created by scanning a scene one line at a time, e.g. using a motorised stage or the motion of a moving vehicle on which the camera 102 is fitted to scan across the landscape (push broom scanning). The complete image will normally comprise a known number of lines of data. In other embodiments, the partial hyperspectral data can represent more than one line of a complete image, or another portion/block of the complete image. In some cases, the steps of FIG. 2 are performed “live” (or substantially in real time) on hyperspectral image data as it is received from the camera 102, but in other cases, the partial data is received from a data store containing data representing a complete pre-recorded hyperspectral image.

At step 204 the received hyperspectral image data is processed by the application 106 in order to produce mean and covariance estimates. Statistically-based methods of spectral image processing are based on estimates of the mean and spectral covariance of the hyperspectral imagery. In general, the type of algorithms with which the method described herein can be used are statistical in nature (on idealised multivariate Gaussian data, the behaviour of the algorithms can be predicted mathematically, although this does not happen in practice). Conventionally, the mean μ and covariance Σ are calculated exactly by these algorithms using the entire data of a complete image. In contrast, the method performed by the application 106 is based on the assumption that each line of data received represents a random sample of the complete image. The mean and covariance of the line ( μ̅ and Σ̅) are “unbiased estimators” of the global mean and covariance for the complete image, meaning they should be accurate estimates. This is shown below for a new line of data s with n′ pixels:

$$\overline{μ} ← \frac{n \overline{μ} + {n}^{′} mean ( s )}{n + {n}^{′}} , \sum ← \frac{n \overline{\sum } + {n}^{′} covariance ( s )}{n + {n}^{′}}$$

This allows the method to run one or more hyperspectral algorithms using the estimated mean and covariance it calculates without having to wait for more data to be received.

In the example method, the estimated mean and covariance values are used by two hyperspectral image processing algorithms 206A (a target detection algorithm), 206B (an anomaly detection algorithm), but it will be understood that the method can use the estimates with any reasonable number, from one upwards, of suitable algorithms that can use the estimates.

At step 208, the results of the hyperspectral image processing algorithms 206A, 206B are shown on the display 108 in any suitable form, e.g. a notification that a target/anomaly has been detected and details regarding the location of the target/anomaly. It will be understood that in embodiments that execute different hyperspectral image processing algorithms that the output can vary to provide any suitable output, e.g. any graphical and/or textual information, an audible warning, etc.

In some embodiments, the estimated mean and covariance can be updated when new data becomes available, in which case processing begins again at step 202 of FIG. 2. The new estimates can be calculated as an average between the mean and covariance of the new data and the previous/existing estimates.

It should be noted that embodiments do not need to store any previous image data because simply storing the mean and covariance is enough. This means that the embodiments can be executed without having storage requirements increase over time.

Applications of the method described herein can include using the real time detection results to send only the important portions of imagery to a ground operator, and using detection results to cue a telephoto camera to capture a high detail image of areas of interest. Other example applications include ones based on the known Reed-Xi (RX), Adaptive Matched Filter (AMF) or Adaptive Cosine Estimator (ACE) algorithms.

1. A method of hyperspectral image processing including:
receiving partial hyperspectral image data representing a portion of a complete hyperspectral image;
computing estimated mean and covariance values for the partial hyperspectral image data; and
executing a hyperspectral image processing algorithm using the estimated mean and covariance values as estimates of global mean and covariance values for the complete hyperspectral image.

2. A method according to claim 1, further including:
receiving further partial hyperspectral image data representing a further portion of the complete hyperspectral image;
computing new estimated mean and covariance values as an average between the mean and covariance of the further partial hyperspectral image data and previously computed said estimated mean and covariance values; and
executing the hyperspectral image processing algorithm using the new estimated mean and covariance values as estimates of the global mean and covariance values for the complete hyperspectral image.

3. A method according to claim 1, wherein the partial hyperspectral image data comprises a line of the complete hyperspectral image.

4. A method according to claim 3, wherein the partial hyperspectral image data is generated by a hyperspectral scanning process.

5. A method according to claim 4, wherein the partial hyperspectral image data is received directly from an image capture device that generates the partial hyperspectral image data.

6. A method according to claim 1, wherein the partial hyperspectral data is received from a data store containing the complete hyperspectral image.

7. A method according to claim 1, wherein the hyperspectral image processing algorithm comprises one of a target detection algorithm and an anomaly detection algorithm.

8. A method according to claim 1, further including transferring data relating to the hyperspectral image and/or data relating to a result of the hyperspectral image processing algorithm to a remote device.

9. A method according to claim 8, wherein the transferred data comprises a portion of the hyperspectral image for a remote detailed review.

10. A method according to claim 8, wherein the transferred data comprises a direct or indirect request for further hyperspectral image data.

11. A method according to claim 1, further including storing the estimated mean and covariance values for further processing and not storing the partial hyperspectral image data for further processing after the computing of the estimated mean and covariance values.

12. A computer program product encoded with computer code that when executed by one or more processors causes a process to be carried out, the process comprising:
receiving partial hyperspectral image data representing a portion of a complete hyperspectral image;
computing estimated mean and covariance values for the partial hyperspectral image data; and
executing a hyperspectral image processing algorithm using the estimated mean and covariance values as estimates of global mean and covariance values for the complete hyperspectral image.

13. Hyperspectral image processing apparatus including:
a first computing device configured to receive partial hyperspectral image data representing a portion of a complete hyperspectral image;
a second computing device configured to compute estimated mean and covariance values for the partial hyperspectral image data; and
a third computing device configured to execute a hyperspectral image processing algorithm using the estimated mean and covariance values as estimates of global mean and covariance values for the complete hyperspectral image;
wherein the first, second, and third computing devices can be the same computing device or a plurality of different computing devices.

14. Hyperspectral image processing apparatus according to claim 13, wherein the first, second, and third computing devices are implements in a portable camera with at least one of an on board processor and a display.

15. A method according to claim 2, wherein the partial hyperspectral image data comprises a line of the complete hyperspectral image.

16. A method according to claim 15, wherein the partial hyperspectral image data is generated by a hyperspectral scanning process.

17. A method according to claim 16, wherein the partial hyperspectral image data is received directly from an image capture device that generates the partial hyperspectral image data.

18. A computer program product according to claim 12, the process further including:
receiving further partial hyperspectral image data representing a further portion of the complete hyperspectral image;
computing new estimated mean and covariance values as an average between the mean and covariance of the further partial hyperspectral image data and previously computed said estimated mean and covariance values; and
executing the hyperspectral image processing algorithm using the new estimated mean and covariance values as estimates of the global mean and covariance values for the complete hyperspectral image.

19. A computer program product according to claim 18, wherein the partial hyperspectral image data comprises a line of the complete hyperspectral image.

20. A computer program product according to claim 19, wherein the partial hyperspectral image data is generated by a hyperspectral scanning process, and the partial hyperspectral image data is received directly from an image capture device that generates the partial hyperspectral image data.
